(19) United States
(12) Patent Application Publication
(10) Pub. No.: US 2007/0153495 A1
(43) Pub. Date: Jul. 5, 2007

(54) Illumination mechanism for mobile digital imaging

(76) Inventors: Dongxue Wang (Michael), Palatine, IL (US); Kevin W. Johnson, Mundelein, IL (US); Rachel F. Karnani, Chicago, IL (US); Timothy R. Whiting, Kildeer, IL (US)

Correspondence Address: MOTOROLA INC, 600 NORTH US HIGHWAY 45, ROOM AS437, LIBERTYVILLE, IL, 60048-5343, US

(21) Appl. No.: 11/321,319

(22) Filed: Dec. 29, 2005

(51) Int. Cl. F21V 9/16

(52) U.S. Cl. 362/84

(57) ABSTRACT

An electronic device (100) with an image capture device (160) includes an illumination mechanism (170). The illumination mechanism (170) includes a light source with a light shaping mechanism adapted and constructed to shape light emitted from the light source into a generally ‘V’ shaped illumination pattern (300).

### FIELD OF THE INVENTION

The present invention relates generally to illumination devices for use in mobile digital imaging.

### BACKGROUND

Mobile digital imaging has been a major driving force in the development and differentiation of a variety of multi-function electronic devices, such as camera phones. As development has progressed, consumers have increasingly high demands and expectations of the image quality obtained with such devices. It is known to provide camera phones with some mechanism for illumination, for use as a flash for photography or to indicate a variety of functions of the device. The design criteria for flash photography with typical digital cameras differ markedly from the design criteria for portable multi-function electronic devices such as camera phones. For example, standard digital cameras frequently use xenon-based flash systems, the space and power requirements of which are unsuitable for camera phones.

One proposed solution for camera phone flash function is to employ a light-emitting diode (LED) as an illumination source for flash functions and non-photography display. Although the LED is relatively efficient in its use of space and power, it is less than optimal as a photographic flash. FIG. 9 shows a typical LED flash illumination pattern 900. As shown by line 910, the center of the field of view is brightly lit while the edges of the field of view are not as brightly lit. Although this line 910 shows only vertical (Y) coordinate values along the field of view, a similar illumination pattern also occurs along horizontal (X) coordinate values. Putting together the vertical and horizontal illumination patterns results in essentially a center of a two-dimensional field of view being brightly lit while edges, especially the corners, of the two-dimensional field of view are not as brightly lit.

This darkening of the edges of a field of view caused by an LED flash is exacerbated by “vignetting”, i.e., unintended darkening of the outer edges and corners of a photographic image, caused by the small lenses of multi-function devices. Although it is possible to mitigate vignetting by optimizing lens design (e.g., lowering the chief ray angle and enlarging the lens), such methods are impractical in small multi-function devices such as camera phones. FIG. 10 shows a typical vignetting plot 1000. The plot 1000 assumes a uniform illumination (unlike FIG. 9) and shows illumination counts along a horizontal (X) axis of a field of view. A shown by line 1010, the edges of the field of view will be darker due to lens imperfections while the center of the field of view will be brightest. Although this line 1010 only shows horizontal (X) coordinate values along the field of view, a similar vignetting pattern also occurs along the vertical (Y) coordinate values. Similar to the illumination pattern shown in FIG. 9, the vignetting pattern results in edges of a two-dimensional field of view being darker than the center.

The combination of the darkened edges/corners caused by an LED flash plus the darkened edges/corners caused by vignetting can result in an unacceptable digital image from a multi-function device such as a camera phone. Digital anti-vignetting is a technique that can compensate for vignetting of a digital image. This process, however, would increase the digital signal processor (DSP) load for devices such as mega-pixel camera phones, which would increase power consumption and decrease battery life and may even affect other functions of the camera phone, such as vocoder functions that also use the DSP.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a multi-function electronic device incorporating digital camera and illumination features in accordance with some embodiments of the invention.

FIG. 2 shows a general circuit diagram for the electronic device shown in FIG. 1.

FIG. 3 shows a graph illustrating a V-shaped illumination pattern in accordance with various embodiments of the invention.

FIG. 4 illustrates a phosphor-coated LED chip for use in the general circuit diagram shown in FIG. 2 in accordance with various embodiments of the invention.

FIG. 5 illustrates an LED chip with a center ray blocker for use in the general circuit diagram shown in FIG. 2 in accordance with various embodiments of the invention.

FIG. 6 illustrates a first example of an LED lamp with multiple LED chips for use in the general circuit diagram shown in FIG. 2 in accordance with various embodiments of the invention.

FIG. 7 illustrates a second example of an LED lamp with multiple LED chips for use in the general circuit diagram shown in FIG. 2 in accordance with various embodiments of the invention.

FIG. 8 illustrates an example of a red-green-blue (RGB) LED lamp with multiple LED chips for use in the general circuit diagram shown in FIG. 2 in accordance with various embodiments of the invention.

FIG. 9 shows a typical prior art LED flash illumination pattern.

FIG. 10 shows a typical prior art vignetting plot.

### DETAILED DESCRIPTION

Before describing in detail embodiments, it should be observed that the embodiments reside primarily in combinations of method steps and apparatus components related to electronic device incorporating illumination features. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments described herein may be comprised of one or more conventional processors and unique stored program instructions that control the one or more processors to implement, in conjunction with certain non-processor circuits, some, most, or all of the functions of the electronic device incorporating illumination features described herein. The non-processor circuits may include, but are not limited to, a radio receiver, a radio transmitter, signal drivers, clock circuits, power source circuits, and user input devices. As such, these functions may be interpreted as steps of a method to perform electronic device incorporating illumination features. Alternatively, some or all functions could be implemented by a state machine in an electronic device incorporating illumination features that has no stored program instructions, or in one or more application specific integrated circuits (ASICs), in which each function or some combinations of certain of the functions are implemented as custom logic. Of course, a combination of the two approaches could be used. Thus, methods and arrangements for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

An electronic device with an image capture device includes an illumination mechanism. The illumination mechanism includes a light source and a light shaping mechanism adapted and constructed to shape light emitted from the light source into a generally ‘V’ shaped illumination pattern having a center dimmer than edges and corners of a field of view. The V-shaped illumination pattern compensates for vignetting caused by lens imperfections, which creates darkening at the edges of a field of view.

The light shaping mechanism can be implemented at the LED chip level and at the LED lamp level. At the LED chip level, a phosphor coating of varying thickness shapes the light from an LED chip to achieve the desired V-shaped illumination pattern. Also at the LED chip level, an optical control member, such as a blaze grating, a phase grating, or another type of light-shaping diffuser, bends light rays from the LED chip to form the desired V-shaped illumination pattern. Blaze gratings can be fabricated using digital optics, holography, or computer generated holograms. Alternately, a center ray blocker can be placed in front of the LED chip to block center rays of light and create the V-shaped illumination pattern.

At the LED lamp level, a multi-chip driver is used to control at least three LED-chips within a single LED lamp. In one example, each of the three LED chips has a different spatial orientation, which promotes the V-shaped illumination pattern. In another example, the multi-chip driver controls a center LED chip to be dimmer than at least two of the perimeter LED chips. In yet another example, the LED chips are red, green, and blue, and an optical control member, such as a blaze grating, a phase grating, or other light-shaping diffuser bends light rays from the red, green, and blue LED chips to form the desired V-shaped illumination pattern.

In addition to the V-shaped illumination pattern, the electronic device can include an infrared LED chip to assist in auto-focus features, a “warning” light which flashes to alert a subject of the photograph before the image capture device captures an image, and a continuous light source (as opposed to a brief flash) for use when walking or cycling in the evening or during low ambient light conditions.

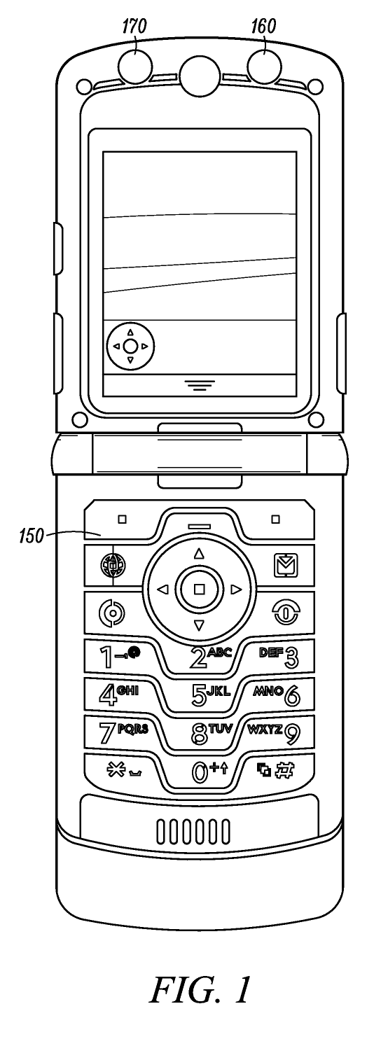

FIG. 1 shows an electronic device 100 incorporating an image capture device 160 such as a digital camera and an illumination mechanism 170. Although the electronic device 100 is illustrated as a camera phone, it is also contemplated that the illumination features described herein can be implemented on other multi-function electronic devices in which flash photography may be a desirable function, such as night vision devices, home security arrangements, and the like. The illumination mechanism 170 includes a light-shaping feature to control the illumination pattern of the light emitted from the illumination mechanism 170.

In addition to the image capture device 160 and the illumination mechanism 170, the electronic device 100 includes a control interface 150. When the control interface 150 is actuated to take a digital photograph, the illumination mechanism 170 can emit a first light signal to indicate that a picture is about to be taken or to determine the distance between the camera and the subject, then flashes in conjunction with image capture to illuminate the subject of the photograph. Because the electronic device 100 is a multi-function device, the control interface 150 is also used to control other functions such as dialing a telephone number, storing contact information, and listening to digital recordings of music.

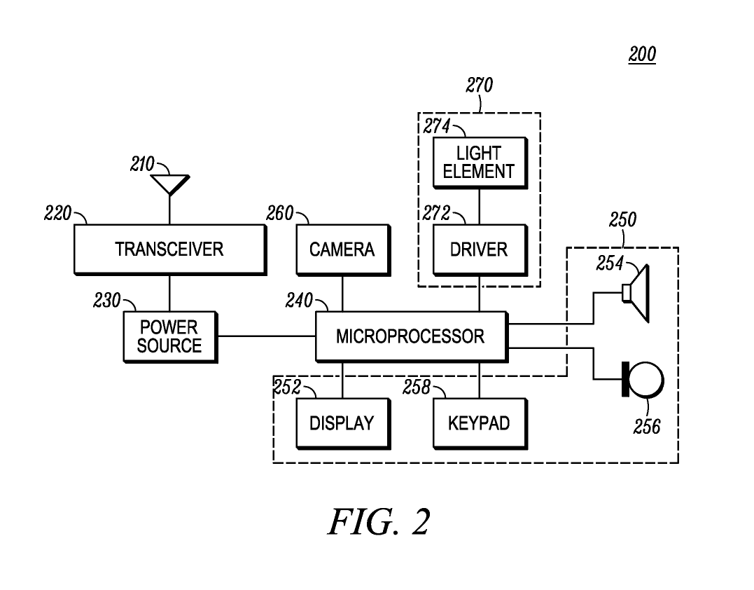

FIG. 2 shows a general circuit diagram 200 for the electronic device 100 shown in FIG. 1. Because the electronic device 100 is shown as a camera phone, there is an antenna 210, a transceiver 220, and a power source 230. Other elements, such as memory and a digital signal processor (DSP) are not shown separately. The electronic device 100 also includes a microprocessor 240 and a user interface 250. The user interface 250 includes a display 252, a loudspeaker 254, a microphone 256, and a keypad 258. The user interface 250 also includes an image capture device 260 and an illumination mechanism 270. The illumination mechanism 270 has a lighting element driver 272 and at least one lighting element such as a light emitting diode (LED) lamp 274. Other LEDs (not shown) can share the driver 272. The other LEDs can provide backlighting for the display 252 and the keypad 258, for example.

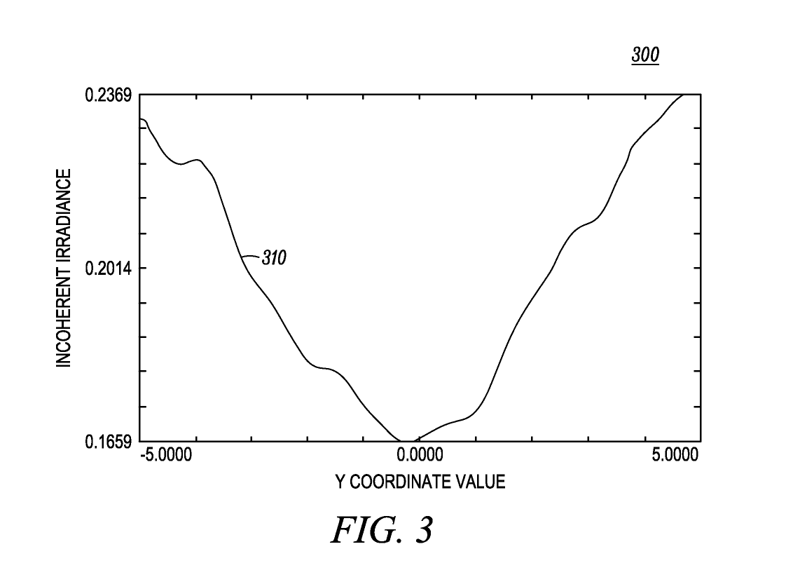

FIG. 3 shows a graph 300 of an illumination pattern achieved by the illumination mechanism 170, 270. The pattern 310 illustrates a generally ‘V’ shaped illumination pattern specifically tailored to illuminate the field of view of the image capture device 160, 260, with flash brightness increasing toward the outer edges and corners of the image. Although the line 310 only shows vertical (Y) coordinate values along the field of view, a similar illumination pattern occurs along horizontal coordinate values. Putting together the vertical and horizontal illumination patterns for illumination mechanism 170, 270 results in essentially the edges and corners of a two-dimensional field of view being brightly lit while the center of the two-dimensional field of view is not as brightly lit.

The V-shaped illumination pattern compensates for vignetting, such as that shown in FIG. 10, by increasing the lighting for areas in a field of view that are prone to darkening due to lens imperfections. In addition to reducing vignetting, the V-shaped illumination pattern can also serve to perform “red-eye” reduction. Since the red-eye phenomenon is mainly caused by strong reflection from the illumination center, concentrating illumination at the edges of the photograph rather than at the center reduces red-eye.

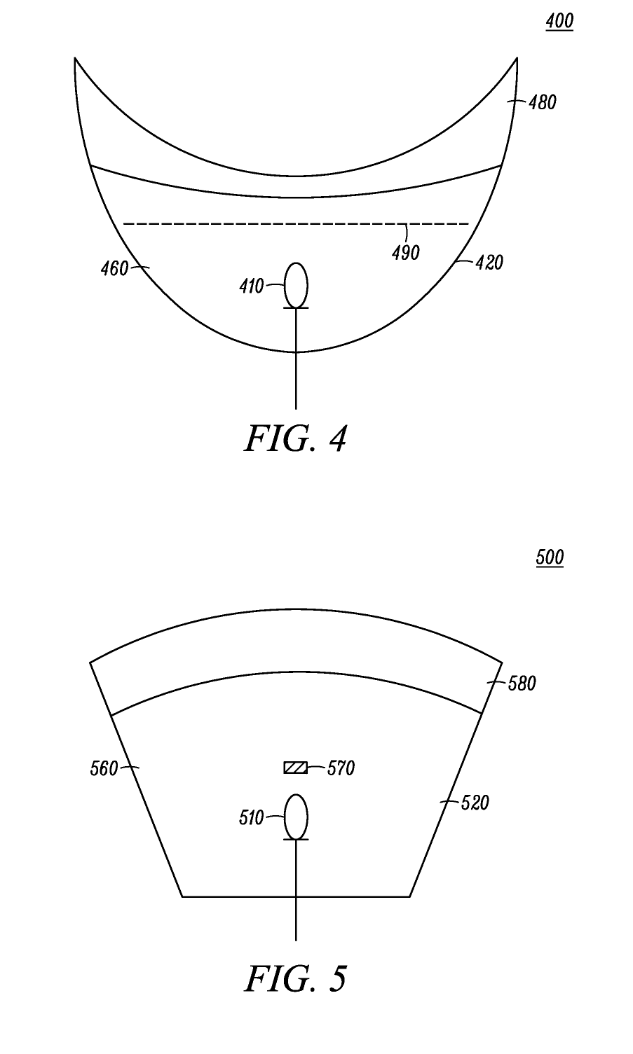

The V-shaped illumination pattern 310 of the illumination mechanism 170, 270 can be implemented in a number of ways. FIG. 4 illustrates a phosphor-coated LED chip 410 for use in the general circuit diagram shown in FIG. 2 in accordance with various embodiments of the invention. An LED lamp 400 includes an LED chip 410 as an illumination element. The LED chip 410 has a reflector 420 (shown in a parabolic shape, but other shapes can be substituted) and is embedded in epoxy 460. The non-reflector surface of the epoxy 460 is coated with a selective phosphor coating 480. In a selective phosphor coating, the phosphor is engineered so that light emitted from the LED lamp 400 is shaped to have less intensity at its center than at its edges in accordance with the illumination pattern 310 shown in FIG. 3. For example, phosphor layer varies in thickness such that there is a higher intensity light emitted from the LED lamp 400 at the edges. To create white light from the LED lamp 400, the LED chip 410 emits ultraviolet or blue light, which pumps yellowish phosphors in the selective phosphor coating 480 to result in light that appears white.

Optionally or alternately, the LED lamp 400 can include an optical control member 490, such as a blaze grating, a diffractive optics layer (phase grating), a holographic diffuser, or other type of light-shaping diffuser, within the epoxy 460 that directs light rays from the LED chip 410 toward the edges of the LED lamp 400. By adding an optical control member 490, the light rays from the LED chip 410 already have a substantially V-shaped illumination pattern before reaching the phosphor coating 480, and the phosphor coating 480 augments the V-shaped illumination pattern.

Although only a single LED chip 410 is shown, which would be consistent with an ultra-violet/blue LED chip and yellowish phosphor, the selective phosphor coating technique can be applied to multi-chip LED lamps, which would be consistent with an LED lamp having a combination of green and blue LED chips.

FIG. 5 illustrates an LED chip 510 with a center ray blocker 570 for use in the general circuit diagram shown in FIG. 2 in accordance with various embodiments of the invention. Similar to FIG. 4, the LED chip 510 illumination element of an LED lamp 500 has a reflector 520 (shown having a cup shape but other shapes can be substituted) and is embedded in epoxy 560. In this embodiment, a phosphor coating 580 of the non-reflective surface of the epoxy 560 is standard and has a uniform thickness. Instead of a selective phosphor coating, there is a center ray blocker 570 blocking the center rays of the light emitted from the LED chip 510. The center ray blocker 570 can have light absorption properties and/or light reflection properties. As shown, the center ray blocker 570 is embedded in the epoxy 560 directly in front of the LED chip 510. In a variation of this embodiment, a thin film reflector stack is coated on the LED chip 510 to guide more light to be emitted from the periphery of the LED chip than the center. This center ray blocker 570, along with the remainder of the LED lamp 500 creates the desired V-shaped illumination pattern 310 shown in FIG. 3.

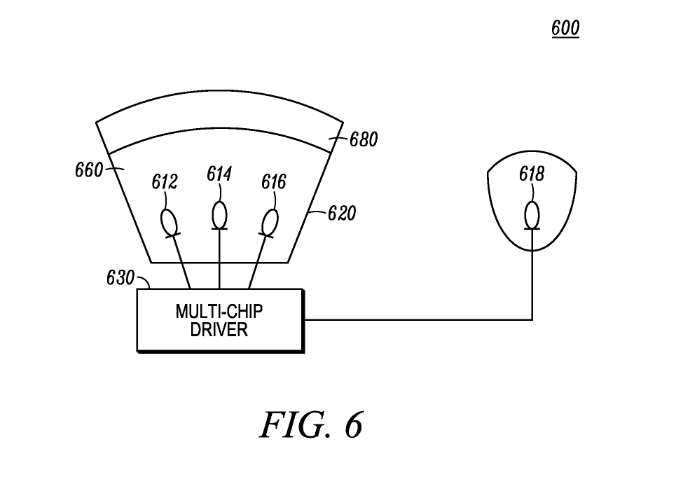

FIG. 6 illustrates a first example of an LED lamp 600 with multiple LED chips 612, 614, 616 for use in the general circuit diagram shown in FIG. 2 in accordance with various embodiments of the invention. In this first example, three ultraviolet/blue LED chips 612, 614, 616 are embedded in epoxy 660 in a single, multi-chip LED lamp 600. The LED lamp 600 has a reflector 620 (shown having a cup shape but other shapes can be substituted) and a yellowish phosphor coating 680 having a standard geometry. Each of the LED chips 612, 614, 616 has different spatial orientations, designed to create the V-shaped illumination pattern 310 shown in FIG. 3. Each LED chip 612, 614, 616 can be individually controlled using a multi-chip driver 630 as the lighting element driver 272 shown in FIG. 2, or all three LED chips 612, 614, 616 can be controlled with a single-chip driver. Although three LED chips are shown, more LED chips can be included. For example, five LED chips can be included in an X-pattern, one at each end of the two lines and one in the center, to create the V-shaped illumination pattern 310 shown in FIG. 3.

Although this first example shows three LED chips within a single LED lamp, an alternate embodiment is to have each LED chip embedded within a single LED lamp, resulting in three LED lamps with different spatial orientations. A drawback to having three LED lamps is that the overall illumination mechanism 270 would be larger compared to the example shown, due to the additional packaging required.

An optional LED chip 618 could be an infrared light emitter. In this drawing, the infrared LED chip 618 is shown in a separate LED lamp. Alternately, the infrared LED chip 618 can be embedded into the multi-chip LED lamp. This LED chip 618 can be implemented with this embodiment as well as other embodiments such as the LED lamp 400 shown in FIG. 4 and the LED lamp 500 shown in FIG. 5. The multi-chip driver 630 can control the infrared LED chip 618 to provide a light source for auto-focusing. The infrared LED chip 718 can be used to sense a subject's distance from the image capture device 160, 260, and activate the flash if the subject is at a distance where flash illumination will have a positive impact on picture quality. Another option is to include a distinctive colored warning light LED chip instead of, or in addition to, the infrared LED chip 618. The operation of the warning light LED chip would be similar to that of the infrared LED chip 618, but the purpose would be to warn the subject of the photograph that a photo is soon to be taken. A third option is to operate the LED lamp for use as a continuous (non-flash) light source when, for example, walking or cycling in the evening or during low ambient light conditions.

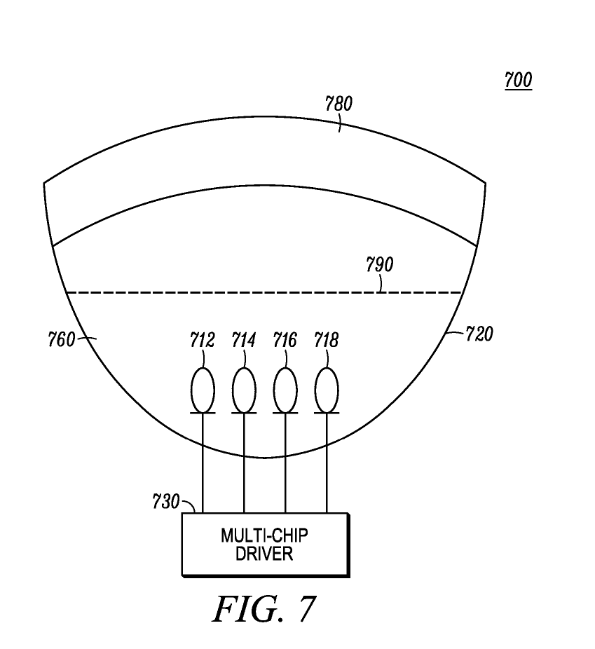

FIG. 7 illustrates a second example of an LED lamp 700 with multiple LED chips 712, 714, 716 for use in the general circuit diagram shown in FIG. 2 in accordance with various embodiments of the invention. In this second example, ultraviolet/blue LED chips 712, 714, 716 have the same spatial orientation but are offset within the epoxy 760. A reflector 720 having a parabolic shape and the yellowish phosphor coating 780 are similar to LED lamp reflectors and uniform phosphor coatings previously described. In order to achieve the V-shaped illumination pattern 310 shown in FIG. 3, the multi-chip driver 730 controls the center LED chip 714 to be dimmer than the outer LED chips 712, 716. Additionally, an optional control member 790, such as a blaze grating, a diffractive optics layer (phase grating), a holographic diffuser, or another type of light-shaping diffuser, within the epoxy 760 can direct light rays toward the edges of the field of view.

An optional LED chip 718 could be an infrared light emitter. The optional LED chip 718 can be embedded into the multi-chip LED lamp 700 as shown to provide a light source for auto-focusing a subject of the photograph. Alternately, the optional LED chip 718 can be housed in a separate LED lamp as taught in FIG. 6. The multi-chip driver 730 can control the optional LED chip 718 to sense a subject's distance from the image capture device 160, 260, and activate the flash if the subject is at a distance where flash illumination will have a positive impact on picture quality.

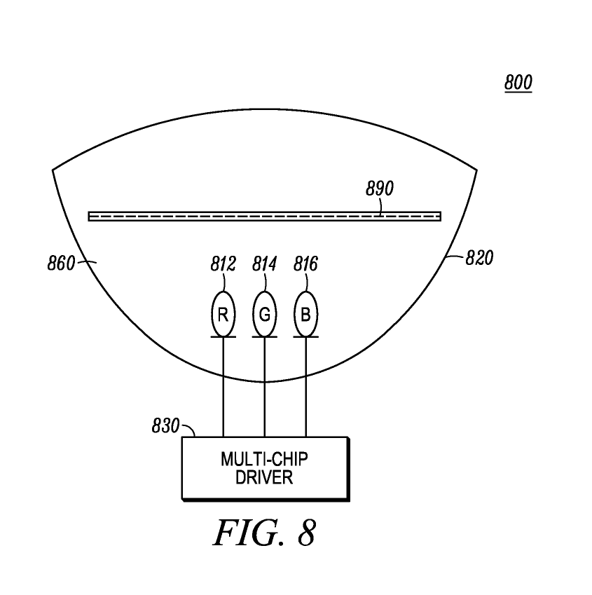

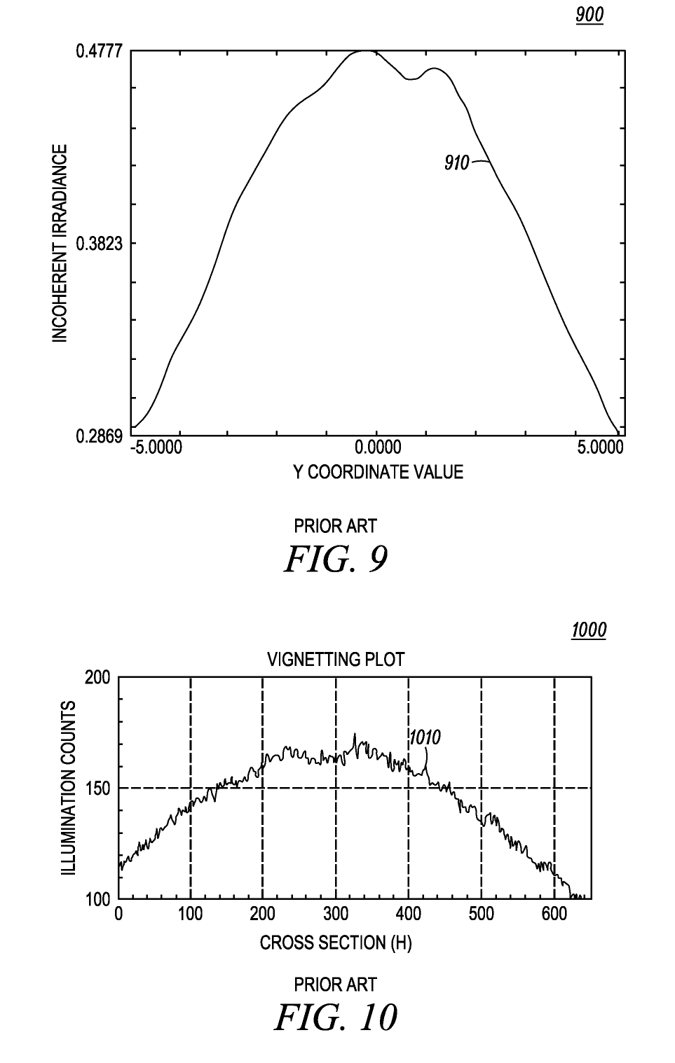

FIG. 8 illustrates an example of a red-green-blue (RGB) LED lamp 800 with multiple LED chips 812, 814, 816 for use in the general circuit diagram shown in FIG. 2 in accordance with various embodiments of the invention. A first LED chip is red, a second LED chip is green, and a third LED chip is blue. The LED chips 812, 814, 816 are embedded in epoxy 860 and have a reflector 820. A control member 890, such as a blaze grating, a diffractive optics layer (phase grating), holographic diffuser, or other type of light-shaping diffuser, within the epoxy 860 alters lights rays from each LED chip and directs the light rays toward the edges of the field of view.

Each LED chip 812, 814, 816 can be individually controlled using a multi-chip driver 830 as the lighting element driver 272 shown in FIG. 2 to achieve white light or colored light. The use of RGB multi-chips permits selective color tuning of the flash to achieve color-coding and other desired photographic effects. Further, the use of an RGB multi-chip LED facilitates a first “warning” light to be of a distinctive color, e.g., red, without an additional LED chip. An optional infrared LED chip can also be included as previously described.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. In an electronic device including an image capture device, an illumination mechanism comprising the following:
a light source; and
a light shaping mechanism adapted and constructed to shape light emitted from the light source into a generally ‘V’ shaped illumination pattern.

2. An illumination mechanism in accordance with claim 1, wherein the light source comprises at least one LED chip.

3. An illumination mechanism in accordance with claim 2, wherein the light shaping mechanism comprises a phosphor coating of varying thickness.

4. An illumination mechanism in accordance with claim 3, wherein the phosphor coating is yellowish.

5. An illumination mechanism in accordance with claim 3, wherein the LED chip emits light in the ultra-violet and blue range.

6. An illumination mechanism in accordance with claim 2, wherein the light shaping mechanism comprises an optical control member.

7. An illumination mechanism in accordance with claim 6, wherein the optical control member comprises at least one from a group of: a blaze grating and a phase grating.

8. An illumination mechanism in accordance with claim 2, wherein the light shaping mechanism comprises at least one center ray blocker for blocking center rays of light emitted from the at least one LED chip.

9. An illumination mechanism in accordance with claim 1, further comprising a multi-chip driver, and wherein the light source comprises at least a first LED chip, a second LED chip, and a third LED chip.

10. An illumination mechanism in accordance with claim 9, wherein the first LED chip, the second LED chip, and the third LED chip emit light of similar wavelengths.

11. An illumination mechanism in accordance with claim 10, wherein the first LED chip, the second LED chip, and the third LED chip each have different spatial orientations.

12. An illumination mechanism in accordance with claim 10, wherein the multi-chip driver controls the first LED chip to be dimmer than the second LED chip and the third LED chip.

13. An illumination mechanism in accordance with claim 9, wherein the first LED chip emits red light, the second LED chip emits green light, and the third LED chip emits blue light.

14. An illumination mechanism in accordance with claim 14, further comprising an optical control member.

15. An illumination mechanism in accordance with claim 15, wherein the optical control member comprises at least one from a group of: a blaze grating and a phase grating.

16. An illumination mechanism in accordance with claim 1, wherein the light source is operable as a continuous light source.

17. An illumination mechanism in accordance with claim 1, further comprising an infrared LED chip.

18. An illumination mechanism in accordance with claim 17 wherein the infrared LED chip provides an infrared light source for auto-focusing.

19. An illumination mechanism in accordance with claim 1, wherein the electronic device comprises one of a group of: a camera phone, a night vision device, and a home security arrangement.

20. An illumination mechanism in accordance with claim 1, wherein a light source driver causes the light source to flash a warning light before the image capture device captures an image.
